(19) United States
(12) Patent Application Publication
(10) Pub. No.: US 2026/0160860 A1
(43) Pub. Date: Jun. 11, 2026

(54) Road target classification and recognition method based on millimeter-wave traffic radars

(71) Applicant: Hangzhou City University, Hangzhou City (CN)

(72) Inventors: Fang Wang, Hangzhou City (CN); Yulu He, Hangzhou City (CN); Zhenyin Wen, Hangzhou City (CN); Lingzhe Kong, Hangzhou City (CN)

(73) Assignee: Hangzhou City University, Hangzhou City (CN)

(21) Appl. No.: 19/295,570

(22) Filed: Aug. 9, 2025

(30) Foreign Application Priority Data
Dec. 10, 2024 (CN) 2024118127852

(51) Int. Cl. G01S 7/41; G01S 13/06; G01S 13/89; G01S 13/91; G08G 1/01

(52) U.S. Cl. CPC G01S 7/415; G01S 13/06; G01S 13/89; G01S 13/91; G08G 1/0116

(57) ABSTRACT

The present invention discloses a road target classification and recognition method based on millimeter-wave traffic radars, comprising following steps of: S1—collecting motion characteristics and scattering characteristics information of measured targets via millimeter-wave radars, obtaining point cloud data of the measured targets, and preprocessing the point cloud data to obtain target point cloud data; S2—processing the target point cloud data based on target characteristics to obtain target classification data; and S3—performing posteriori and feedback on the target classification data output. The present invention has the advantages of high recognition rate and recognition accuracy, less occupied resources and less computing power, and has good promotion prospects and applications in the field of smart transportation.

### CROSS-REFERENCE

This application claims the benefit of priority from China Patent Application No. CN 2024118127852 filed on Dec. 10 2024, the contents of which are hereby incorporated by reference in their entirety.

### TECHNICAL FIELD

The present invention relates to the field of intelligent transportation technology, and in particular to a road target classification and recognition method based on millimeter-wave traffic radars.

### BACKGROUND TECHNOLOGY

Smart transportation is a huge intelligent system that maximizes the functions and efficiency of traffic management through perception, analysis, prediction, intervention and control. The perception system is the first link of smart transportation, helping the smart transportation system to realize functions such as traffic flow monitoring, congestion management, accident warning, etc., and improve traffic efficiency and safety. The autonomous collection of real-time traffic data information usually relies on sensor monitoring, various vehicle-mounted equipment and mobile applications. Currently, the most widely used technical means include: laser radar, high-definition camera, millimeter-wave radars, microwave radar, coil, and road traffic microwave integrated detector.

Millimeter-wave radars are radars that work in the millimeter wave bands, in traffic applications, emit low-energy millimeter wave signals to the detected road areas, and detect the real-time status by identifying the millimeter wave signals reflected by pedestrians, motor vehicles and non-motor vehicles on the roads.

In the existing technology, when millimeter-wave radars are used in the intelligent infrastructure of vehicle-road-cloud integration, the vehicle trajectory information of motor vehicles, such as the target vehicles'IDs, lanes, lengths, widths, speeds, heading angles, etc., needs to meet the vehicle queuing detection and multi-traffic target classification recognition computing power, the recognition efficiency is low, the recognition accuracy is low, the lane resource occupancy rate is high, and the detection computing power is complex.

### SUMMARY OF THE INVENTION

The present invention provides a road target classification and recognition method based on millimeter-wave traffic radars with high recognition efficiency, accurate recognition, low resource occupation and computing power, which can solve at least one of the above technical problems.

In order to solve the above technical problems, the present invention adopts following technical solutions: a road target classification and recognition method based on millimeter-wave traffic radars is implemented by using a road target classification and recognition system based on millimeter-wave traffic radar and comprises a target information preprocessing module, a tracking and classification module, and an adaptive closed-loop module; wherein the target information preprocessing module is used to collect point cloud data and preprocess to obtain target point cloud data, the tracking and classification module is connected to the target information preprocessing module to receive the target point cloud data and process to obtain target classification data, the adaptive closed-loop module is connected to the tracking and classification module to perform posteriori and feedback on the output target classification data; and the road target classification and recognition method based on millimeter-wave traffic radars further comprises following steps of:
S1—collecting motion characteristics and scattering characteristics information of measured targets via millimeter-wave radars, obtaining point cloud data of the measured targets, and preprocessing the point cloud data to obtain target point cloud data;
S2—processing the target point cloud data based on target characteristics to obtain target classification data; and
S3—performing posteriori and feedback on the target classification data output.

Further, operation in the S1 about preprocessing further comprises:
S11—eliminating data that seriously does not conform to road target speeds based on traffic rules;
S12—deleting noise points and false data based on RCS characteristics of the measured targets;
S13—filtering data that does not conform to vehicle movement areas and movement trends based on installation positions of millimeter-wave radars and characteristics of static objects; and
S14—fusing 3-5 frames of the point cloud data to increase point cloud density.

Further the S2 further comprises:
S21—obtaining target associated point cloud information: analyzing the point cloud data associated with targets in a tracking stage, namely, traversing tracked targets, and obtaining point cloud data information associated with current frames of the targets, wherein the point cloud data information comprises at least numbers, RCS and motion information under spherical coordinates;
S22—processing classification feature parameters, further comprising:
S221—converting the point cloud data information obtained into Cartesian coordinates with millimeter-wave radars positions as origins;
S222—for targets of which point cloud data numbers meet conditions, using L-Shape algorithm to obtain circumscribed rectangles of the point cloud data of measured targets, using heading angles of the measured targets to correct deviation, obtaining vertical distances between long sides of the circumscribed rectangles and normal directions of the Millimeter-wave radars, and then obtaining length sizes of the measured targets;
S23—setting classification feature structures of candidate targets: according to data analysis results of single-target vehicles of different types such as people, non-motorized vehicles, small vehicles and large vehicles, setting feature information, wherein the feature information at least comprises classification status bits, thresholds of numbers of classifiable target point clouds, target point cloud layer type size ranges and classification execution number thresholds; and the feature information is associated with the measured targets at each new start track and the feature information is initialized; and
S24—building a classifier to classify targets: traversing track targets of current frames to detect classification status bits of each target, wherein 0 means that target types have been determined and the step is skipped, non-0 means that the target types have not been classified or is being classified and have not been determined, wherein for unclassified target sizes, 3 frames of data are stored and mean values are calculated, and point cloud layer type size ranges are compared with the mean values, types of the targets are determined after cumulative number of times a certain type exceeds classification execution number thresholds, and classification status bits thereof are set to 0, and the targets will no longer be classified.

Further, the S3 further comprises:
S31—receiving 3-5 frames of tracked targets, grouping targets of same categories that have been determined during a tracking process into different groups, removing targets whose data features have too large deviations from an overall category in category groups, resetting determined categories thereof, and performing category discrimination again; and
S32—considering that large vehicles have long bodies, point clouds thereof are dense and easy to split, target splitting is likely to occur at a tracking level, setting BOX limits if the target types are determined to be large vehicles, wherein within ranges racking layers will no longer start new tracks.

Compared with the prior art, the present invention has following beneficial effects:
I. High recognition rate and accuracy: Through the sequential processing of the target information preprocessing module, the tracking and classification module and the adaptive closed-loop module, the classification of the measured targets has a higher recognition rate and robustness.
II. Less resources and computing power involved: Compared with the classification of radar and vision combined and the classification of measured targets through neural networks, the present invention classifies the measured targets during the tracking process on the millimeter-wave radars chip, occupies less resources, does not require a large amount of data training, and avoids adding additional computing power.

### BRIEF DESCRIPTION OF THE DRAWINGS

The drawings described herein are used to provide further understanding of the present application and constitute a part of the present application. The illustrative embodiments of the present application and their descriptions are used to explain the present application and do not constitute improper limitations on the present application.

FIG. 1 is a flow chart of a road target classification and recognition method based on millimeter-wave traffic radars according to an embodiment of the present invention.

FIG. 2 is a block diagram of a structure of a system for classifying and identifying road targets based on millimeter-wave traffic radars according to an embodiment of the present invention.

FIG. 3 is a point cloud image before preprocessing according to an embodiment of the present invention.

FIG. 4 is a point cloud image after preprocessing according to an embodiment of the present invention.

FIG. 5 is a schematic diagram of steps for processing target characteristics of target point cloud data according to an embodiment of the present invention.

FIG. 6 is a block diagram of a computer device according to an embodiment of the present invention.

The markups in the attached drawings are indicated as: 1—target information preprocessing module; 2—tracking and classification module; 3—adaptive closed-loop module.

### SPECIFIC EMBODIMENTS

The technical solutions in the embodiments of the present invention will be clearly and completely described below in conjunction with the drawings in the embodiments of the present invention. Obviously, the described embodiments are only part of the embodiments of the present invention, rather than all of the embodiments. In the absence of conflict, the embodiments in this application and the features in the embodiments can be combined with each other. Based on the embodiments in the present invention, all other embodiments obtained by ordinary technicians in this field without making creative work are within the scope of protection of the present invention.

It should be noted that the meaning of “and/or” in the full text includes three parallel solutions. Taking “A and/or B” as an example, it includes solution A, solution B, or solutions that satisfy both A and B. In addition, the technical solutions between the various embodiments can be combined with each other, but they must be based on the ability of ordinary technicians in the field to implement them. When the combination of technical solutions is contradictory or cannot be implemented, it should be considered that such combination of technical solutions does not exist and is not within the protection scope required by the present invention.

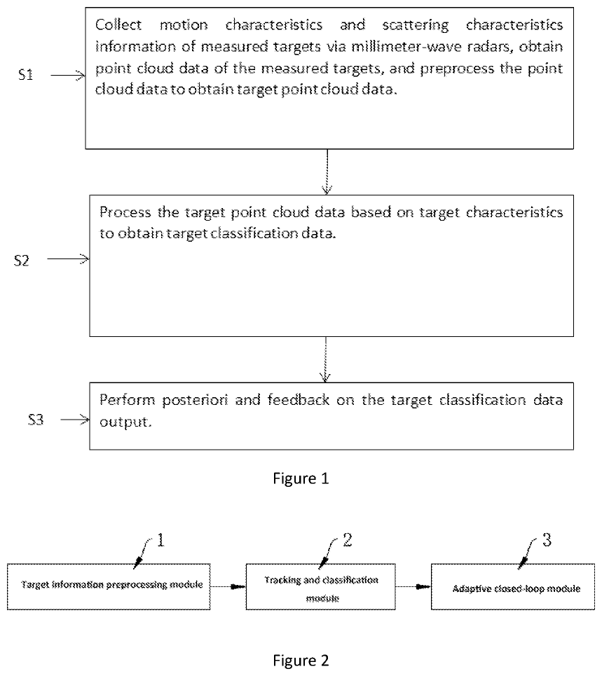

Please refer to FIG. 1, an embodiment of the present invention provides a road target classification and recognition method based on millimeter-wave traffic radars, comprising following steps of:
S1—collecting motion characteristics and scattering characteristics information of measured targets via millimeter-wave radars, obtaining point cloud data of the measured targets, and preprocessing the point cloud data to obtain target point cloud data;
S2—processing the target point cloud data based on target characteristics to obtain target classification data; and
S3—performing posteriori and feedback on the target classification data output.

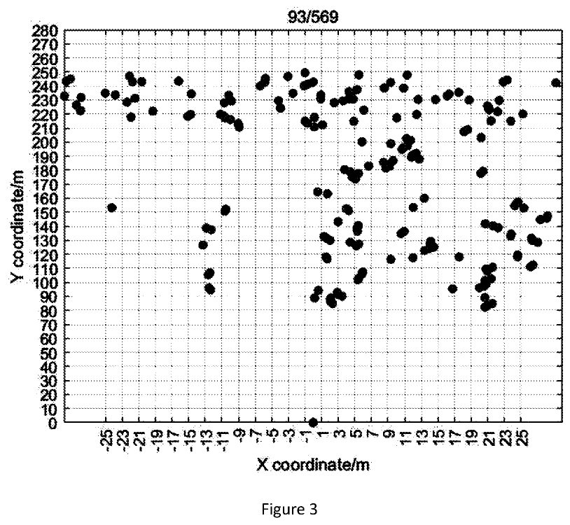

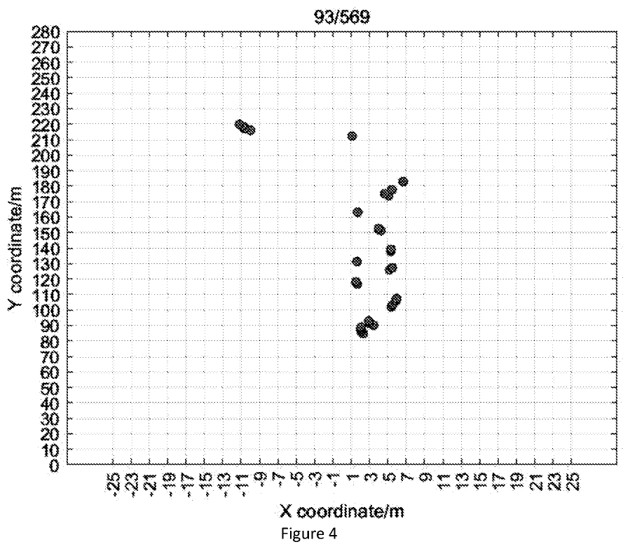

Please refer to FIGS. 3-4, in the present embodiment, operation in the S1 about preprocessing further comprises:
S11—eliminating data that seriously does not conform to road target speeds based on traffic rules;
S12—deleting noise points and false data based on RCS characteristics of the measured targets;
S13—filtering data that does not conform to vehicle movement areas and movement trends based on installation positions of millimeter-wave radars and characteristics of static objects; and
S14—fusing 3-5 frames of the point cloud data to increase point cloud density. Usually, the transmission frequency of the point cloud is 10 HZ-20 HZ, which does not affect the timing of the measured target data. At the same time, since the millimeter-wave radars used in traffic are usually installed on traffic lights about 8 meters away, due to the complexity of the installation locations and environment, the problem of sparse point clouds is inevitable, so the number of frames needs to be fused.

The information collection of the millimeter-wave radars on the targets has significant advantages in the motion characteristics of the objects and the scattering characteristics of the radars. By emitting microwave pulses, the millimeter-wave signals reflected by the targets on the roads are processed to obtain the motion characteristics and scattering characteristics of the detected targets, which are usually called the point cloud information of the millimeter-wave radars. The point cloud information includes the positions, speeds, angle information of the detected targets relative to the millimeter-wave radars, and the RCS of the targets. RCS is a physical quantity that measures the echo intensity generated by the target under the irradiation of the radar waves. The target information itself has the boundedness of motion and RCS characteristics, the correlation of the same target data or the same area data, and although it has undergone powerful signal processing technology, there are still inevitable errors and unrecognizable complexity.

Based on this, it is necessary to preprocess the collected point cloud data to improve the data efficiency of the subsequent algorithm processing of the measured target. As shown in FIG. 3, it is a point cloud map that has not been preprocessed, and as shown in FIG. 4, it is a point cloud map that has been preprocessed and only retains the point cloud map related to the measured target vehicle.

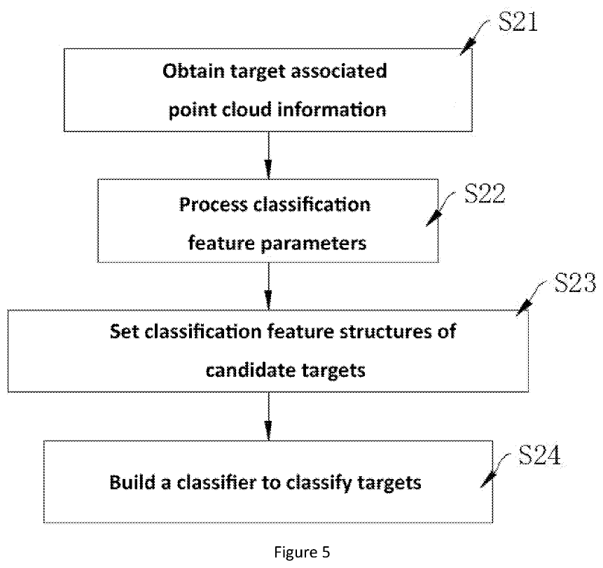

Please refer to FIG. 5, in the present embodiment, the S2 further comprises:
S21—obtaining target associated point cloud information: analyzing the point cloud data associated with targets in a tracking stage, namely, traversing tracked targets, and obtaining point cloud data information associated with current frames of the targets, wherein the point cloud data information comprises at least numbers, RCS and motion information under spherical coordinates; and the motion information comprises speeds, distances, angles, etc. relative to millimeter-wave radars.
S22—processing classification feature parameters, further comprising:
S221—converting the point cloud data information obtained into Cartesian coordinates with millimeter-wave radars positions as origins;
S222—for targets of which point cloud data numbers meet conditions, using L-Shape algorithm to obtain circumscribed rectangles of the point cloud data of measured targets, using heading angles of the measured targets to correct deviation, obtaining vertical distances between long sides of the circumscribed rectangles and normal directions of the millimeter-wave radars, and then obtaining length sizes of the measured targets;
S23—setting classification feature structures of candidate targets: according to data analysis results of single-target vehicles of different types such as people, non-motorized vehicles, small vehicles and large vehicles, setting feature information, wherein the feature information at least comprises classification status bits, thresholds of numbers of classifiable target point clouds, target point cloud layer type size ranges and classification execution number thresholds; and the feature information is associated with the measured targets at each new start track and the feature information is initialized; and
S24—building a classifier to classify targets: traversing track targets of current frames to detect classification status bits of each target, wherein 0 means that target types have been determined and the step is skipped, non-0 means that the target types have not been classified or is being classified and have not been determined, wherein for unclassified target sizes, 3 frames of data are stored and mean values are calculated, and point cloud layer type size ranges are compared with the mean values, types of the targets are determined after cumulative number of times a certain type exceeds classification execution number thresholds, and classification status bits thereof are set to 0, and the targets will no longer be classified.

In the millimeter-wave radars processing stack, target classification belongs to the posteriori step after the radar positioning processing layer. That is, after the millimeter-wave radars obtains the point cloud through ADC sample processing, the target tracking information is obtained and the target characteristics are processed through tracking, clustering, Kalman and other algorithms.

Kalman filtering was once called the minimum mean square estimator, which minimizes the mean square estimation error of the linear random system using noisy linear sensors (data). The position of the target of interest is tracked by the sensor, and the target distance, speed, azimuth and other observations obtained by the sensor often contain noise. The dynamic information of the target is combined with the observation results to suppress the influence of noise and obtain a more accurate estimate of the target position, thereby achieving target tracking.

In the present embodiment, the S3 further comprises:
S31—receiving 3-5 frames of tracked targets, grouping targets of same categories that have been determined during a tracking process into different groups, removing targets whose data features have too large deviations from an overall category in category groups, resetting determined categories thereof, and performing category discrimination again; and
S32—considering that large vehicles have long bodies, point clouds thereof are dense and easy to split, target splitting is likely to occur at a tracking level, setting BOX limits if the target types are determined to be large vehicles, wherein within ranges racking layers will no longer start new tracks.

Please refer to FIG. 2, an embodiment of the present invention further provides a road target classification and recognition method based on millimeter-wave traffic radars, comprising a target information preprocessing module 1, a tracking and classification module 2, and an adaptive closed-loop module 3;
wherein the target information preprocessing module 1 is used to collect point cloud data and preprocess to obtain target point cloud data, the tracking and classification module 2 is connected to the target information preprocessing module 1 to receive the target point cloud data and process to obtain target classification data, the adaptive closed-loop module 3 is connected to the tracking and classification module 2 to perform posteriori and feedback on the output target classification data;

In the present embodiment, the target information preprocessing module 1 uses millimeter-wave radars to collect information on the motion characteristics and scattering characteristics of the targets to be measured to obtain the point cloud data, and the point cloud data at least includes the position/speed/angle data of the target to be measured relative to the millimeter-wave radars, and the RCS data of the target to be measured.

In the present embodiment, the target information preprocessing module 1 filters out the data in the point cloud data that does not meet the requirements of traffic regulations, vehicle motion characteristics and vehicle RCS characteristics, and performs frame fusion on the filtered and eliminated data to obtain the target point cloud data.

In the present embodiment, the tracking and classification module 2 includes a Kalman prediction unit, a target association unit, a data allocation unit, a target classification unit and a data update unit.

The Kalman prediction unit is used to perform a priori estimation of the trackable objects based on the operation of time n−1 state estimation.

The target association unit is used to associate the point cloud data with the existing tracking target, set the wave gate function, establish the relevant centroid restriction function of the three-dimensional space, and group and associate the existing measurement points with the unique target.

The data allocation unit is used to allocate the trajectory of the measurement value and create a measurement value group associated with each tracking target.

The target classification unit is used to extract features from the associated point cloud data of each unique tracking target, including the number of associated point clouds, the distance dimension of the point clouds, the extraction and area division of the point cloud RCS features, and calculate the minimum bounding rectangle by the distance dimension of the associated point cloud cluster to determine the lengths of the targets, and then determine the target categories based on these features. The target classification unit needs to collect and compare data sets of different categories of measured targets, and divide the data-specific thresholds of the number of associated points, distance dimension, and target characteristics RSC into different categories;

The data update unit is used to update the tracking targets, and updates the Kalman gain, posterior state vector and error for each determined tracking target.

An embodiment of the present invention further provides a computer-readable storage medium storing a computer program. When the computer program is executed by a processor, the processor executes the steps of the above-mentioned road target classification and recognition method based on millimeter-wave traffic radars.

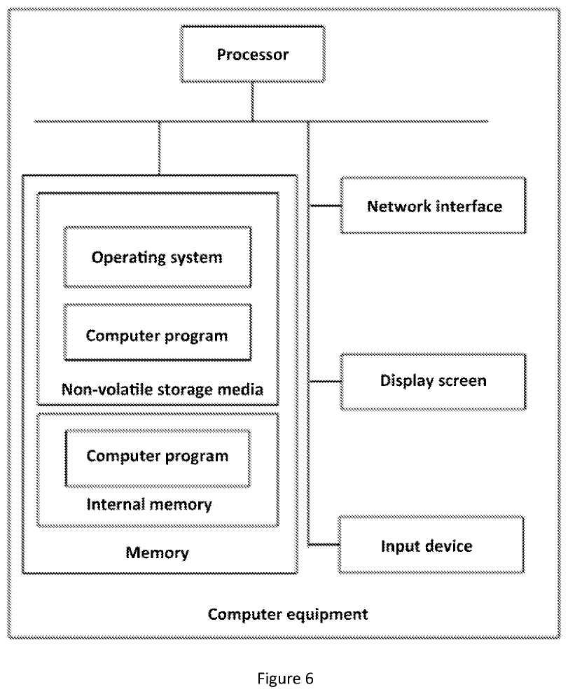

Please refer to FIG. 6, an embodiment of the present invention further provides a computer device, including a memory and a processor, wherein the memory stores a computer program, and when the computer program is executed by the processor, the processor executes the steps of the above-mentioned road target classification and recognition method based on millimeter-wave traffic radars.

An embodiment of the present invention further provides a computer program product comprising instructions, which, when executed on a computer, enables the computer to execute the steps of the above-mentioned road target classification and recognition method based on millimeter-wave traffic radars.

It is understandable that the system, device and storage medium provided in the embodiments of the present invention correspond to the method provided in the embodiments of the present invention, and the explanation, examples and beneficial effects of the relevant contents can refer to the corresponding parts in the above methods.

It should be noted that those skilled in the art can understand that all or part of the steps implemented in the embodiments of the present invention can be implemented in whole or in part by software, hardware, firmware or any combination thereof. When implemented using hardware, it can be implemented in whole or in part in the form of purchased standard parts or modified parts. When implemented by using software, it can be implemented in whole or in part in the form of a computer program product. The computer program product includes one or more computer instructions. When the computer program instructions are loaded and executed on a computer, the process or function described in the embodiment of the present application is generated in whole or in part. The computer may be a general-purpose computer, a special-purpose computer, a computer network, or other programmable device. The computer instructions may be stored in a computer-readable storage medium or transmitted from a computer-readable storage medium to another computer-readable storage medium. For example, the computer instructions may be transmitted from one website, computer, server or data center to another website, computer, server or data center by wired (e.g., coaxial cable, optical fiber, digital subscriber line (DSL)) or wireless (e.g., infrared, wireless, microwave, etc.). The computer-readable storage medium may be any available medium that a computer can access or a data storage device such as a server or data center that includes one or more available media integrated. The available medium may be a magnetic medium (eg, a floppy disk, a hard disk, a magnetic tape), an optical medium (eg, a DVD), or a semiconductor medium (eg, a solid state disk (SSD)).

In summary, the present invention proposes a road target classification and recognition method based on millimeter-wave traffic radars. Compared with the existing technology, the present invention has the advantages of high recognition rate and recognition accuracy, less resources occupied and less computing power involved. Through the sequential processing of the target information preprocessing module, the tracking classification module and the adaptive closed-loop module, the classification of the measured target has a higher recognition rate and robustness. At the same time, compared with the combined classification of radar and vision and the classification of the measured targets through neural networks, the present invention classifies the measured targets during tracking on the millimeter-wave radar chip, occupies less resources, does not require a large amount of data training, and avoids adding additional computing power. It has good promotion prospects and application value in the field of smart transportation.

It should be understood that the examples and implementation modes described herein are for illustrative purposes only and are not intended to limit the present invention. Those skilled in the art may make various modifications or changes based on the examples and implementation modes. Any modifications, equivalent substitutions, improvements, etc. made within the spirit and principles of the present invention should be included in the scope of protection of the present invention.

1. A road target classification and recognition method based on millimeter-wave traffic radars, implemented by using a road target classification and recognition system based on millimeter-wave traffic radar and comprising a target information preprocessing module (1), a tracking and classification module (2), and an adaptive closed-loop module (3),
wherein the target information preprocessing module (1) is used to collect point cloud data and preprocess to obtain target point cloud data, the tracking and classification module (2) is connected to the target information preprocessing module (1) to receive the target point cloud data and process to obtain target classification data, the adaptive closed-loop module (3) is connected to the tracking and classification module (2) to perform posteriori and feedback on the output target classification data; and
the road target classification and recognition method based on millimeter-wave traffic radars further comprises following steps of:
S1—collecting motion characteristics and scattering characteristics information of measured targets via millimeter-wave radars, obtaining point cloud data of the measured targets, and preprocessing the point cloud data to obtain target point cloud data;
S2—processing the target point cloud data based on target characteristics to obtain target classification data; and
S3—performing posteriori and feedback on the target classification data output.

2. The road target classification and recognition method based on millimeter-wave traffic radars according to claim 1, wherein operation in the S1 about preprocessing further comprises:
S11—eliminating data that seriously does not conform to road target speeds based on traffic rules;
S12—deleting noise points and false data based on RCS characteristics of the measured targets;
S13—filtering data that does not conform to vehicle movement areas and movement trends based on installation positions of millimeter-wave radars and characteristics of static objects; and
S14—fusing 3-5 frames of the point cloud data to increase point cloud density.

3. The road target classification and recognition method based on millimeter-wave traffic radars according to claim 2, wherein the S2 further comprises:
S21—obtaining target associated point cloud information: analyzing the point cloud data associated with targets in a tracking stage, namely, traversing tracked targets, and obtaining point cloud data information associated with current frames of the targets, wherein the point cloud data information comprises at least numbers, RCS and motion information under spherical coordinates; and
S22—processing classification feature parameters, further comprising:
S221—converting the point cloud data information obtained into Cartesian coordinates with millimeter-wave radars positions as origins;
S222—for targets of which point cloud data numbers meet conditions, using L-Shape algorithm to obtain circumscribed rectangles of the point cloud data of measured targets, using heading angles of the measured targets to correct deviation, obtaining vertical distances between long sides of the circumscribed rectangles and normal directions of the Millimeter-wave radars, and then obtaining length sizes of the measured targets;
S23—setting classification feature structures of candidate targets: according to data analysis results of single-target vehicles of different types such as people, non-motorized vehicles, small vehicles and large vehicles, setting feature information, wherein the feature information at least comprises classification status bits, thresholds of numbers of classifiable target point clouds, target point cloud layer type size ranges and classification execution number thresholds; and the feature information is associated with the measured targets at each new start track and the feature information is initialized; and
S24—building a classifier to classify targets: traversing track targets of current frames to detect classification status bits of each target, wherein 0 means that target types have been determined and the step is skipped, non-0 means that the target types have not been classified or is being classified and have not been determined; and for unclassified target sizes, 3 frames of data are stored and mean values are calculated, and point cloud layer type size ranges are compared with the mean values, types of the targets are determined after cumulative number of times a certain type exceeds classification execution number thresholds, and classification status bits thereof are set to 0, and the targets will no longer be classified.

4. The road target classification and recognition method based on millimeter-wave traffic radars according to claim 1, wherein the S3 further comprises:
S31—receiving 3-5 frames of tracked targets, grouping targets of same categories that have been determined during a tracking process into different groups, removing targets of which data features have too large deviations from an overall category in category groups, resetting determined categories thereof, and performing category discrimination again; and
S32—considering that large vehicles have long bodies, point clouds thereof are dense and easy to split, target splitting is likely to occur at a tracking level, setting BOX limits if the target types are determined to be large vehicles, wherein within ranges of the BOX limits, tracking layers will no longer start new tracks.
